(19) United States
(12) Patent Application Publication
(10) Pub. No.: US 2011/0191154 A1
(43) Pub. Date: Aug. 4, 2011

(54) Methods and Apparatus for Networking and Controlling Electronic Displays

(76) Inventors: Cedric Tremayne Johnson, Vallejo, CA (US); Ray Gulley Evans, Hercules, CA (US); Scott D. Elliott, Holly Springs, NC (US)

(21) Appl. No.: 13/015,200

(22) Filed: Jan. 27, 2011

Related U.S. Application Data
(60) Provisional application No. 61/299,714, filed on Jan. 29, 2010.

(51) Int. Cl. G06Q 30/00

(52) U.S. Cl. 705/14.4

(57) ABSTRACT

In one embodiment disclosed herein, one or more electronic displays operate as part of an advertising display system, such as may he used at a retail store where one or more electronic displays are placed at strategic locations within the retail store and used to provide advertising to shoppers within the retail store. The contemplated advertising display system includes at least one electronic display for displaying advertisements and a display control computer configured to cause the electronic display to display a series of advertisements corresponding to inventoried products. Further, an advertising control computer in the system is configured to compose the series of advertisements and to modify product-pricing information displayed in one or more of the advertisements, as a function of tracked inventory information for the inventoried products.

### RELATED APPLICATIONS

This application claims priority from the U.S. provisional patent application filed on Jan. 29, 2010 and identified by application Ser. No. 61/299,714, and which is incorporated in its entirety by reference herein.

### FIELD OF THE INVENTION

The present invention generally relates to electronic displays, and particularly relates to networking and controlling electronic displays, such as for use in retail advertising locations.

### BACKGROUND

Providing relevant advertising in a timely, controlled manner is challenging in the large-scale retail environment, such as where one retailer operates a large chain of distributed retail stores. All of the stores may carry at least some of the same merchandise but each store may have (and likely will have) differing levels of dynamically changing product inventories. Further, some advertising may be tailored for particular locations, while some advertising may be common across the retail chain. One sees some of these challenges at issue in, for example, U.S. Patent Publication 2010/0153182 A1.

Of course, some retail environments are more complex in terms of how advertising is used, the number of products involved, and the sensitivity to locally stockpiled inventories. Grocery store chains represent one such environment and various approaches to innovating product advertising in such context are known. See, for example, U.S. Pat. Nos. 6,513,016, and 7,231,380.

Yet many challenges remain, both in the specific context of retail advertising and in the broader context of distributed information systems, such as might be used over multiple floors in a large office building or across a university or other campus setting. In this regard, the content of each sign may need to be different, in at least some respects, and the content for some or all signs must change over relatively short intervals—such as day to day, or on an even shorter-duration basis.

### SUMMARY

In one aspect, this document discloses a network of communicatively linked electronic displays. The network includes a centralized content server and a plurality of display nodes, each node comprising an electronic display that is associated with a display control computer. The content server operates as a centralized node for distributing display content to all or targeted ones of the display nodes, according to defined media distribution protocols that provide for efficient and flexible compilation and modification of the content displayed at each display node. In a least one embodiment, a playlist defines the behavior of each electronic display and the content server provides a user interface for compiling content files according to media type, etc., and distributing respective content files and associated playlists to respective ones of the display nodes. Additionally or alternatively, the “local” display control computers provide a user interface for adding or changing content—e.g., adding, deleting, or modifying content files—and changing or adding playlists.

Each display control computer may be associated with one electronic display, such that each display node comprises one electronic display and one display control computer. Alternatively, any given one of the display control computers “drives” more than one electronic display. In such embodiments, the centralized content server sends more than one playlist to the given display control computer, with each playlist defining the behavior of a respective one of the electronic displays controlled by the display control computer. Additionally, multiple playlists may be defined and stored for one electronic display, such as one playlist for morning use, one for afternoon use, and one for evening use. Some or all of the same content files may be used by each such playlist, with each playlist changing, for example, the order, timing, or overlaid information of the content displayed by the electronic display during various times of the day.

Similarly, in cases where more than one electronic display within a given location uses at least some of the same underlying content, the content server need only send such content once to the display control computer(s) at that location, for use on multiple ones of the electronic displays controlled by the display control computer. Moreover, to the extent that a new advertising sequence for a given electronic display reuses at least a portion of the content used in a previous advertising sequence, enabling the new advertising sequence requires sending, for example, just the new playlist and any new or updated media files. In this manner, the order and content of individual advertisements can be varied among displays and updated for given displays, with a very low file transfer overhead.

In one or more embodiments disclosed herein, one or more electronic displays operate as part of an advertising display system, such as may be used at a retail store where one or more electronic displays are placed at strategic locations within the retail store and used to provide advertising to shoppers within the retail store. The contemplated advertising display system includes at least one electronic display for displaying advertisements and a display control computer configured to cause the electronic display to display a series of advertisements corresponding to inventoried products. Further, an advertising control computer in the system is configured to compose the series of advertisements and to modify product-pricing information displayed in one or more of the advertisements, as a function of tracked inventory information for the inventoried products.

In at least one such embodiment, the display control computer and the advertising control computer comprise one computer running one or more computer programs that functionally implement the display control computer and the advertising control computer, For example, a MACINTOSH or WINDOWS computer includes a hard drive or other storage system that holds one or more computer programs, the execution of which by the computer causes it to output video to one or more associated electronic displays, where that video represents a desired series of advertisements having desired content (e.g., pricing and sales timing information) that is defined, for example, by a stored playlist. In this regard, it will be appreciated that the storage system also may be used to store the content identified by the playlist, such as a series of pictures, audio tracks, videos, and pricing data. In another embodiment, the advertising control and display control computers are separate computers, communicatively linked together via a local network, Wide Area Network (WAN), etc.

As regards the “content,” pictures may be JPEG files for example, audio tracks may be .WAV or .AAC files for example, videos may be .MPEG or .MOV files for example, and pricing data may be .TXT files for example, which are used to generate display text or other overlay data that indicates pricing, timing, etc. Advantageously, this arrangement provides for updating pricing or other advertising data simply by changing the underlying text or other data files named in the playlist, without updating any of the typically larger media related files. As another example highlighting the efficiency of this arrangement, the particulars of the series displayed on a given electronic display—e.g., the timing, order, duration, and selected ads—can be changed without changing the underlying media files, simply by updating the playlist. In this regard, the playlist in one embodiment will be understood as “instructions” that define which media files are selected for display and in what order, along with duration/cycle-timing information.

With these examples in mind, in at least one embodiment the advertising control computer is configured to compose a series (of advertisements) by generating an advertising playlist. The advertising playlist identifies a set of electronic content files representing the advertisements to be included in the series. Correspondingly, the display control computer is configured to read and follow the advertising playlist by loading respective electronic content files from a set of electronic content files, for display on the electronic display in accordance with the advertising playlist.

In at least one such embodiment, the advertising playlist includes playback control data that controls at least one of the following parameters during playback of the advertising playlist by the display control computer: a duration for displaying one or more of the advertisements in the playlist; whether scent generation is activated in conjunction with displaying one or more of the advertisements in said playlist; and whether visual highlighting is activated in conjunction with displaying one or more of the advertisements in said playlist. Correspondingly, the electronic display in one or more embodiments includes (either integrally or by co-location) a scent-generation apparatus for generating scents to augment its visual advertising and lights (such as strips or grids) to provide visual highlighting accents that can he activated to draw special attention to certain advertisements.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of one embodiment of an advertising display system.

FIG. 2 is a block diagram of one embodiment of node details for the display and advertising control computers introduced in the advertising display system of FIG. 1.

FIG. 3 is a block diagram of one embodiment of assembly details for the electronic display introduced in the advertising display system of FIG. 1.

FIGS. 4 and 5 are block diagrams of other embodiments of a network of communicatively linked electronic displays that may be used as an advertising display system or otherwise used as a distributed network of intelligently controlled signs for a range of applications.

FIG. 6 is a logic flow diagram of one embodiment of a method for distributing advertising playlists and associated content (e.g., electronic computer files).

FIG. 7 is a block diagram of another embodiment of a network of communicatively linked electronic displays that may be used as an advertising display system.

### DETAILED DESCRIPTION

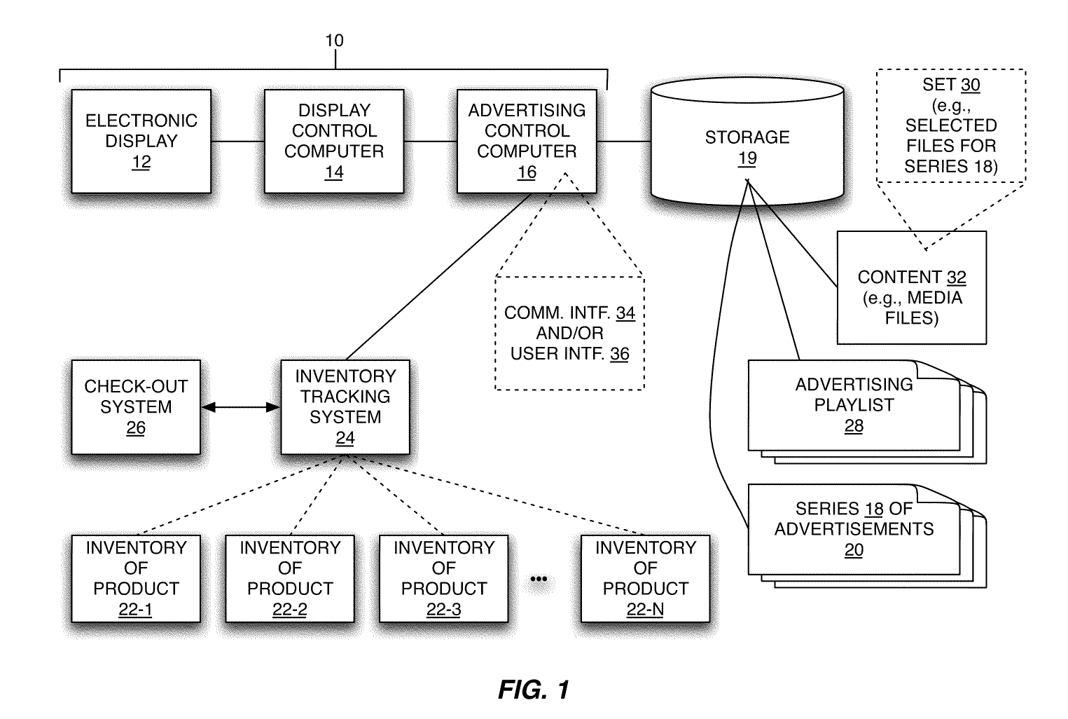

FIG. 1 illustrates an advertising display system 10 comprising an electronic display 12 for displaying advertisements and a display control computer 14 configured to cause the electronic display 12 to display a series 18 of advertisements (“ads”) 20 corresponding to inventoried products 22. The inventoried products 22 are referred to inventoried product 22-1, 22-2, and so on, to indicate that there may be a range of product types, and varying levels of inventories for different products. Further, depending upon the application, some of the products 22 may be perishable and some may not be.

An inventory tracking system 24 tracks changing levels of inventory for one or more of the inventoried products 22, based on receiving sales data from a check-out system 26 (such as a retail department or grocery store). The inventory tracking system 24 also may update its inventory data based on restocking information, such as generated when inventoried products 22 are restocked.

Turning back to the advertising display system 10, the illustrated system further includes an advertising control computer 16 that is configured to compose the series 18 of ads 20 and modify product pricing information displayed in one or more of the ads 20, as a function of tracked inventory information for the inventoried products 22. For example, the series 18 of ads 20 includes a sequence of three advertisements, which can be denoted as ads 20-1, 20-2, and 20-3, for clarity. Ad 20-1 corresponds, for example, to the inventoried product 22-1, while ad 20-2 corresponds to the inventoried product 22-2, and so on.

Each ad 20 comprises, for example, a background image overlaid with text-based pricing/sale information. In this regard, each ad 20 may be understood as being represented by an associated set of computer files within the electronic content 32 held in the storage unit 19, which may be memory and/or disk storage. For example, an image file that shows the product and a text file that includes pricing/sales information for the product. Of course, additional related files may be included in the set, such as additional images, video, audio, and scent generation and/or other ad “highlighting” control files.

The advertising control computer 16 can, for example, be configured to change the text information for one or more of the ads 20, to reflect price changes corresponding to changing inventory levels for respective ones of the inventoried products 22. Thus, in one or more embodiments, the advertising control computer 16 is configured to dynamically update the advertising playlist 28 as a function of changing levels of inventoried products 22, as indicated by tracked inventory information provided by the inventory tracking system 24. In at least one embodiment, the advertising control computer 16 is configured to compose the series 18 by omitting an individual ad 20 from a predefined series of ads 20 responsive to determining that the inventoried product 22 corresponding to the individual ad 20 is out of stock, so as to prevent the electronic display 12 from advertising products 22 that are currently unavailable.

Further, in one or more embodiments, the advertising control computer 16 is configured to compose the series 18 by generating an advertising playlist 28 that identifies a set 30 within the electronic content 32 (e.g., computer files) representing the ads 20 to be included in the series 18. The display control computer 14 in turn is configured to read and follow the advertising playlist 28 by loading respective files from said set 30 of electronic content 32, for output to the electronic display 12 according to the advertising playlist 28.

Note that “output” to the electronic display 12 as used here means outputting video and/or audio-video data, and can also encompass outputting control signaling, such as for scent generation and/or auxiliary lighting controls, etc. In other words, the display control computer 14 will be understood to “output” more than just a simple video signal to the electronic display 12, in at least one embodiment, and those skilled in the art will therefore appreciate that the advertising playlist 28 can identify more than just video and/or audio-video files.

As a further note, it is contemplated herein that the electronic content 32 is stored at the display control computer 14 in addition to, or as an alternative to storing the electronic content 32 at the advertising control computer 16. Storing the electronic content 32 at the display control computer 14 provides a distinct advantage in terms of reducing the amount of data that needs to flow between the advertising control computer 16 and the display control computer 14. For example, if all of the electronic content 32 implicated by advertising playlist 28—i.e., all of the data and control files needed to drive the electronic display 12 in accordance with the advertising playlist 28—already resides at the display control computer 14, then only the advertising playlist 28 need be transferred from the advertising control computer 16 to the display control computer 14.

Taking this example further, the display control computer 14 includes a data storage unit, or has such a unit accessible to it, where that unit stores a larger set of electronic content 32 comprising the computer files associated with a number of ads 20—e.g., the video, image, audio, text, and control files that define the ads 20. (Here, it will be understood that any given ad 20 is represented by one or more computer files, such as a background image file, a video file, a scent control file, an auxiliary lighting control file, a text overlay file for pricing/sale information, etc.)

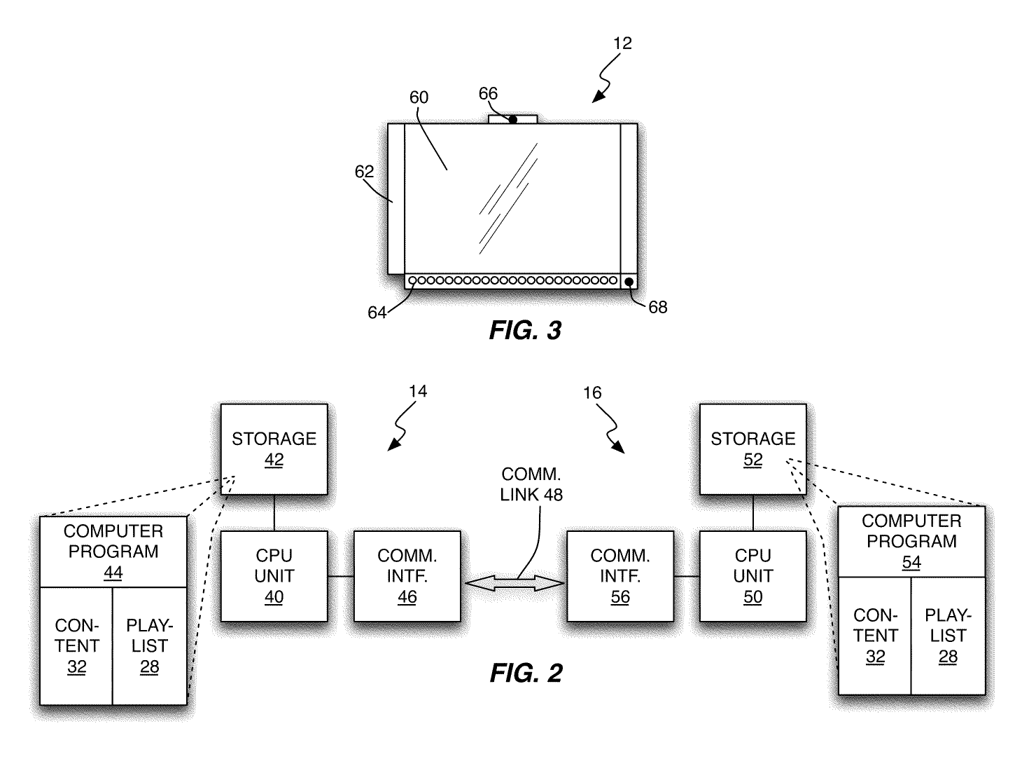

See, for example, FIG. 2 depicting embodiments of the display control computer 14 and the advertising control computer 16. The display control computer 14 includes a CPU unit 40, memory/storage 42 (storing, for example, one or more computer programs 44, electronic content 32, and one or more advertising playlists 28). The display control computer 14 further includes a communication interface 46 that communicatively links it to the advertising control computer 16 through a communication link 48.

The computer program(s) 44 include one or more computer programs embodying the display computer control methods disclosed herein. These programs are, for example, WINDOWS-executable programs that are installed on the display control computer 12. The electronic content 32 includes at least those computer files corresponding to the ads 20 specified in each of the one or more advertising playlists 28, and may comprise a larger repository of ad files. Access to a larger repository of ad files allows new ads 20 to be selected for display without requiring content transfers to the display control computer 14, unless the ads 20 require electronic content 32 not already stored at the display control computer 14.

Similarly, the advertising control computer 16 includes a CPU unit 50, memory/storage 52 (storing, for example, one or more computer programs 54 defining the operation of the advertising control computer 16, electronic content 32, and one or more advertising playlists 28). The advertising control computer 16 further includes a communication interface 56 that communicatively links it to the display control computer 14 through the communication link 48.

In general, the electronic content 32 at the advertising control computer 16 need not match the electronic content 32 at the display control computer 14. However, in one or more embodiments the display control computer 14 has electronic content 32 that includes at least those computer files corresponding to the ads 20 specified in each of the one or more advertising playlists 28 stored at the display control computer 14. Further, the electronic content 32 at the display control computer 14 may include a larger repository of ad files than those needed for the stored playlist(s) 28. Access to a larger repository of ad files allows new ads 20 to be selected for display without requiring content transfers to the display control computer 14, unless the ads 20 require electronic content 32 not already stored at the display control computer 14. In this regard, it will be understood that the electronic content 32 at the advertising control computer 16 may include ad files for as many advertising playlists 28 as are stored or otherwise managed by the advertising display control computer 16.

With such electronic content 32 at the advertising control computer 16 and/or at the display control computer 14, the advertising control computer 16 can compose a series 18 of ads 20 that make use of some or all of the available electronic content 32. Of course, electronic content 32 can be updated from other sources—e.g., from a content server or other network node communicatively coupled to the advertising control computer 16 and/or display control computer 14. Also, as noted, the computers 14 and 16 include user interfaces and local data connections, which allow local users (subject, for example, to password access or other restrictions) to add electronic content 32 for new or updated advertisements.

Such interfaces also provide for playlist creation in at least some embodiments. However, it is contemplated herein that the advertising control computer 16 be configured in one or more embodiments to dynamically compose or modify advertising playlists 28 based on its evaluation of one or more parameters that may change from time to time. For example, in at least one embodiment, the advertising control computer 16 is configured to compose a desired series 18 of ads 20 based on selecting individual ads 20 to include in the series 18 based on at least one of: advertisement preference weightings reflecting relative amounts paid by advertisers associated with respective ones of the ads 20 in the repository of ads; relative inventory levels of the inventoried products 22 associated with the ads 20; and sales performance data for the inventoried products 22 corresponding to the ads 20.

As one example of the above, to the extent that one or more product advertisers pay increased ad fees, their corresponding ads 20 are given more favorable weightings. Those weightings control one or more items, such as at least one of these items: the frequency at which a given ad 20 is displayed; whether scent generation, sound generation, and/or auxiliary lighting or other “highlighting” is used in conjunction with displaying the ad 20; the likelihood (higher with higher ad fees) of being selected for inclusion in a dynamically composed or recomposed series 18 of ads 20; and the duration with which the ad 20 is displayed within a given series 18.

In the same or another embodiment, the advertising control computer 16 composes a series 18 of ads 20 as a function of tracked inventory information by being configured to do one or more of: select individual ads 18 from a (larger) set of ads 20 for inclusion in the series 18; set the order in which individual ads 20 in the series 18 are displayed; set the duration for which individual ads 20 in the series 18 are displayed; and indicate whether advertisement highlighting is to be used for individual ads 20 in the series 18. Here, advertisement highlighting comprises one or more visual, audible, or olfactory effects that can be activated by the display control computer 16 in conjunction with causing a given ad 20 to be displayed on an electronic display 12.

With this approach, certain ads 20 can be shown more or less frequently or with longer or shorter durations, in dependence on the corresponding tracked levels of inventory, or their associated sales data. For example, if sales data indicates that one or more of the inventoried products 22 are selling slowly, advertised pricing can be adjusted downward and/or the ads 20 featuring the slowly selling products can be shown more frequently, for longer duration, and/or highlighting can be used to display them.

Thus, in at least one embodiment, the advertising control computer 16 dynamically controls one or more advertising characteristics associated with displaying ads 20 on the electronic display 12, based on relative levels of product inventory for those inventoried products 22 corresponding to the ads 20 in a series 18 of ads 20. By doing so, the advertising control computer 16 emphasizes those products 22 with relatively high levels of inventory in relation to those products 22 with relatively low levels of inventory.

In this context, “dynamically controlling” the advertising characteristics comprises, for example, updating display control parameters within the advertising playlist 28 that defines the series 18 of ads 20, and providing the updated playlist to the display control computer 14, which may be the only computer that is directly connected to the electronic display 12. Indeed, in at least one embodiment, the display control computer 14 is integrated into the electronic display 12.

Notably, however, to the extent that a new advertising playlist 28 is transferred to the display control computer 14, new electronic content 32 need not be transferred unless the new advertising playlist 28 requires content not already stored at the display control computer 14. By allowing the behavior of the electronic display 12 to be driven by a advertising playlist 28, as processed/interpreted by the display control computer 14, there need be no data-intensive transfers between the advertising control computer 16 and the display control computer 14, at least to the extent that the electronic content 32 needed to display the ads 20 indicated by the advertising playlist 28 is already available at the display control computer 14.

In one or more embodiments, the advertising playlist 28 includes playback control data that controls at least one of the following parameters during playback of the advertising playlist 28 by the display control computer 14: a duration for displaying one or more of the ads 20 in the advertising playlist 28; whether scent generation is activated in conjunction with displaying one or more of the ads 20 in the advertising playlist 28; and whether visual highlighting is activated in conjunction with displaying one or more of the ads 20 in the advertising playlist 28. (Here, “in” the advertising playlist 28 denotes an ad 20 that is identified in or otherwise specified by the advertising playlist 28—thus, the advertising playlist 28 defines the series 18 of ads 20 that are represented by the set 30 of electronic content 32, and the advertising playlist 28 defines the sequence, timing, etc., used to display the ads 20 in the series 18.)

While the advertising control computer 16 can, as noted above, generate the advertising playlist 28, it also can receive it from an external source. Thus, in one embodiment the advertising control computer 16 includes a communications interface 34 for receiving the advertising playlist 28 from an external source. In another embodiment, the advertising control computer 16 includes or is associated with a user interface 36 configured for receiving user input representing advertising playlist selections, which are then used by the advertising control computer 16 to generate the advertising playlist 28. Further aiding playlist generation, the advertising control computer 16 is in one or more embodiments configured with playlist generation software that configures the user interface 36 to display drag-and-drop playlist composition capabilities, along with media/file pick-lists, etc., that facilitate file selection for playlist inclusion by the user.

FIG. 3 illustrates one embodiment of the electronic display 12. The illustrated display 12 comprises a display screen 60, which may be a high-definition TV or video monitor operating at 1080i and/or 1080p, for example. Left and right stereo speakers 62 are disposed on either side of the screen 60, but other speaker placements are contemplated and stereo speakers might not be included in some embodiments. Further, one or more arrays or strips of lights 64 is included in the display assembly—here, one strip of lights 64 is shown along the bottom edge. The lights 64 may be illuminated, flashed, or otherwise controlled to draw attention to the electronic display 12, and thus may be exercised in conjunction with the appearance of specific ads 20 on the screen 60.

In at least one embodiment, the lights 64, which may be a strip of LEDs for example, are multi-colored and are capable of being illuminated in one of several colors, or a mix of colors. As such, the lights 64 can be used by the electronic display 12 to communicate color-coded information to people within sight of the sign. For example, the colors red, yellow, and green can be used to indicate different levels of price discounts, or to communicate information other than pricing—e.g., red may be reserved for important notices or cautions.

The electronic display 12 also includes a security camera 66 (or cameras) in one or more embodiments and it will be understood that the display control computer 14 is configured in at least one such embodiment to receive surveillance video data from the security camera 66. In this regard, the link between the electronic display 12 and the display control computer 14 may include multiple connections, such as video/audio and control signaling from the display control computer 14 to the electronic display 12 and video from the security camera 66 back to the display control computer 14.

One also sees a scent generator 68 installed in the display assembly and it will be understood that the display control computer 14 is configured to provide control signaling—whether in the form of digital data according to a defined protocol, or in the form of discrete control signaling—that actuates the scent generator 68. Scent generation commands are, in one or more embodiments, part of the control information included in the advertising playlists 28. As such, a given advertising playlist 28 is generated, where that playlist includes control information and parameter settings that determine whether the lights 64 and/or scent generator 68 are exercised in conjunction with displaying individual ads 20 in the series 18 of ads 20 that is represented by the advertising playlist 28.

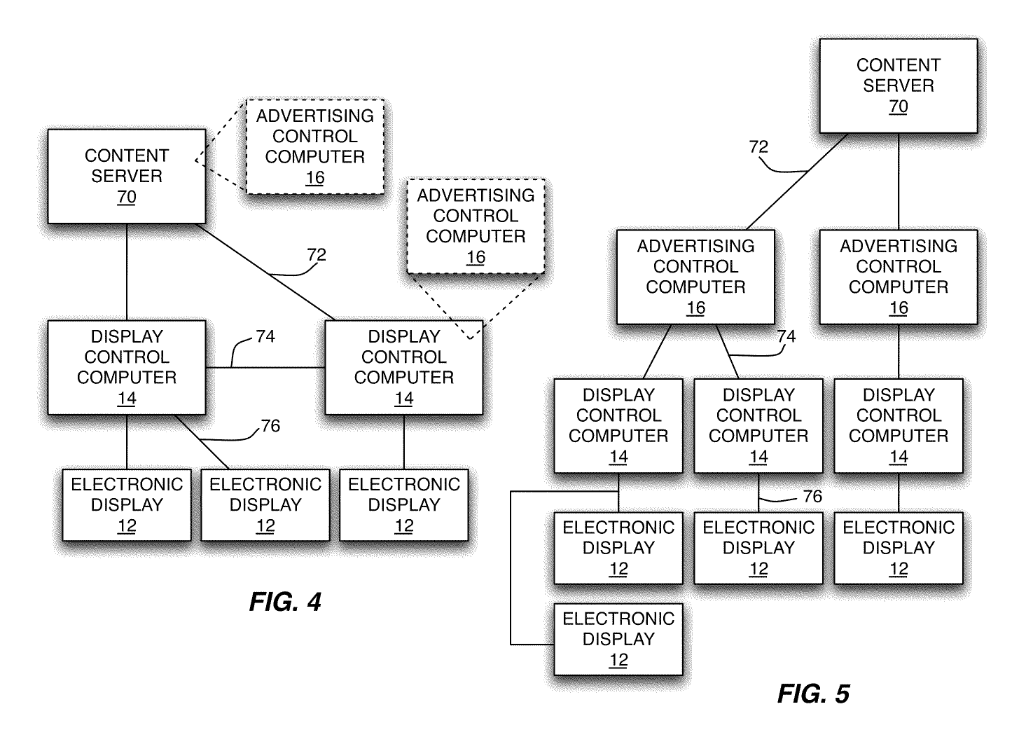

FIG. 4 illustrates yet another arrangement contemplated herein, wherein a possibly centralized advertising content server 70 is configured to distribute electronic content 32 to a plurality of display control computers 14. Here, the centralized advertising content server 70 communicatively couples to one or more display control computer 14 through a communications link 72, which may be an internet-based connection, or may be implemented using known WAN architectures. Each display control computer 14 controls one or more electronic displays 12, and in one embodiment, each display control computer 14 stores the electronic content 32 needed to display the ads 20 intended for display on each electronic display 12 under its control.

In this regard, the centralized advertising content server 70 in one or more embodiments functions as a centralized distribution system that pushes electronic content 32 and advertising playlists 28 for each of one or more electronic displays, reachable through their respective display control computers. In one embodiment, a retail chain uses one or more centralized advertising content servers 70 to coordinate and distribute advertising to a plurality of retail stores, where each store is equipped with one or more electronic displays 12, as controlled by one or more display control computers 14. In this and in other embodiments using a centralized advertising content server 70, the functionality of the advertising control computer 16 can be implemented in the centralized advertising content server 70 and/or in the display control computers 14.

Further, display control computers 14 can be internetworked together, such as to share or exchange electronic content 32, which is particularly useful in the case that one or more of the display control computers 14 implements the functionality of the advertising control computer 16. In such cases, a user—e.g., an authorized operator—uses one display control computer 14 to compile advertising playlists 28 and/or to load electronic content 32, where that electronic content 32 and/or those advertising playlists 28 are used in conjunction with the electronic displays 12 operating under control of that particular display control computer 14, or at least some of the electronic content 32 and/or advertising playlists 28 are sent to another display control computer 14, for use on the electronic displays 12 controlled by that other display control computer 14.

Thus, the communication link 74 between display control computers 14 can be a WAN, LAN or other known type of network link, depending upon whether the display control computers 14 are in the same location on the same local network, or are in different locations. Further, the communication links 76 between the display control computers 14 and their respective electronic displays 12 can be digital and/or analog and can include video/audio and discrete control signaling. In at least one example, the communication links 76 are Ethernet or other computer network links, but it will be understood that the implementation of the communication links 74 and 76 is adapted to suit the particulars of the installation at issue. For example, if the display control computers 14 are co-located with or otherwise integrated with one of the electronic displays 12, then the link to the integrated assembly may be an Ethernet or other computer network link, while the link between the display control computer 14 and electronic display 12 may comprise VGA, HDMI, or other such video connections, plus discrete control signaling to control lighting, scent generation, and security camera interaction.

FIG. 5 illustrates yet another embodiment, in which the centralized advertising content server 70 distributes, e.g., electronic content 32 and/or advertising playlists 28 to advertising control computers 16. Additionally or alternatively, the advertising control computers 16 are, in one or more embodiments, configured to generate advertising playlists 28 and also can be configured to allow users or other network nodes to load electronic content 32.

One also sees that one advertising control computer 16 may control or otherwise support more than one display control computer 14 in at least some embodiments. Likewise, in at least one embodiment, each display control computer 14 may support one electronic display 12, or more than one electronic display 12. Regardless of those details, the hierarchical architecture illustrated in FIG. 5 allows one centralized advertising content server 70 to push electronic content 32 and advertising playlists 28 to multiple advertising control computers 16, for distribution to a plurality of display control computers 14. Further, the advertising control computers 16 and/or the display control computers 14 each provide “local” users with the opportunity to add electronic content 32 and/or add/change advertising playlists 28.

Thus, in one or more embodiments, the advertising control computer 16 as introduced in FIG. 1 can be implemented as a centralized advertising content server 70, where a plurality of the display control computers 14 are networked to the centralized advertising content server 70. Moreover, a plurality of said electronic displays 12 are each coupled to one of the display control computers 14. Still further, the centralized advertising content server 70 is configured to send advertising playlists 28 representing composed series 18 of ads 20 for respective ones of the display control computers 14. The centralized advertising content server 70 and/or the display control computers 14 in one or more embodiments are further configured to dynamically update the advertising playlists 28 as a function of tracked inventory information associated with inventoried products 22 relating to the ads 20.

However implemented, one of the several advantages provided by the teachings herein is that the typically larger, more cumbersome computer files (e.g., media files) comprising the electronic content 32 need not be transferred between nodes unless new content is needed in view of changed advertising playlists 28. In other words, to the extent that playlist changes can be used to change the order or stylization of ads 20 being displayed in a series 18 of ads 20, or to change which ads 20 are selected for inclusion in the series 18, or to change pricing or other display information for such ads 20, those changes do not require new electronic content 32 to be transferred in, unless the changes require electronic content 32 not already present at the involved display control computer 14.

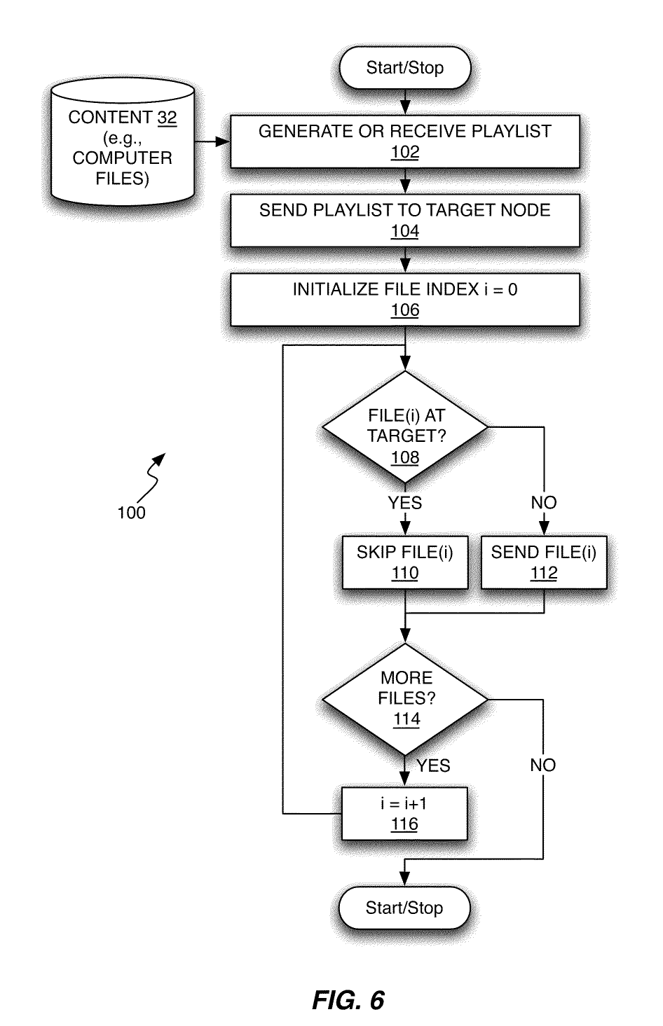

See, for example, the method 100 of FIG. 6. The illustrated method 100 is implemented, for example, at one of the advertising control computers 16 (whether implemented stand-alone or integrated within the centralized advertising content server 70 or one of the display control computers 14). In this regard, the term “target” as used in the flow diagram will be understood to refer to any node remote from the node in which the method is being carried out. For example, assume that a stand-alone advertising control computer 16 carries out the method 100 with respect to a display control computer 14 as the target.

According to the illustration, the method 100 “begins” with generating or receiving an advertising playlist 28 (Block 102). A local user interface of the advertising control computer 16 can be used to support user-generation of the advertising playlist 28. Alternatively, the advertising playlist 28 is generated at a centralized advertising content server 70 and sent to the advertising control computer 16. As a further alternative, the advertising control computer 16 generates the advertising playlist 28 based on executing one or more generation algorithms that are driven by inventory level information, perishable date information, sales history data, etc. Thus, it will be understood that the advertising control computer 16 can receive advertising playlists 28 and/or generate advertising playlists 28 under user control and/or generate advertising playlists 28 according to its automated operations.

The method 100 continues with sending the advertising playlist 28 to the target node (Block 104). The method 100 further continues with initializing a file index (i=0) (Block 106) and determining whether “File(i)” is already present at the target node (Block 108). Here, “File(i)” is one of the computer files (media or control) that are needed by the targeted node to display the series 18 of ads 20 defined by the advertising playlist 28 that is at issue. Further, determining whether the required file is at the target node can include version evaluations, e.g., where an older version of the file at the target node would need to be updated if the advertising playlist 28 requires a newer version.

If the required file is already present at the target node (YES from Block 108), then file transfer for File(i) is skipped (Block 110), thereby avoiding an unnecessary file transfer. On the other hand, if File(i) is not at the target node or is outdated at the target node (NO from Block 108), the method 100 continues with sending File(i) to the target node (Block 112).

Processing continues with determining whether there are any more files identified in the advertising playlist 28. If there are more files to consider (YES from Block 114), processing continues with incrementing the file index to point to the next file (Block 116) and then returns to Block 108, to determine whether or not file transfer is needed for the next file. Once all files implicated by the advertising playlist 28 are evaluated for transfer to the target node, processing “ends.”

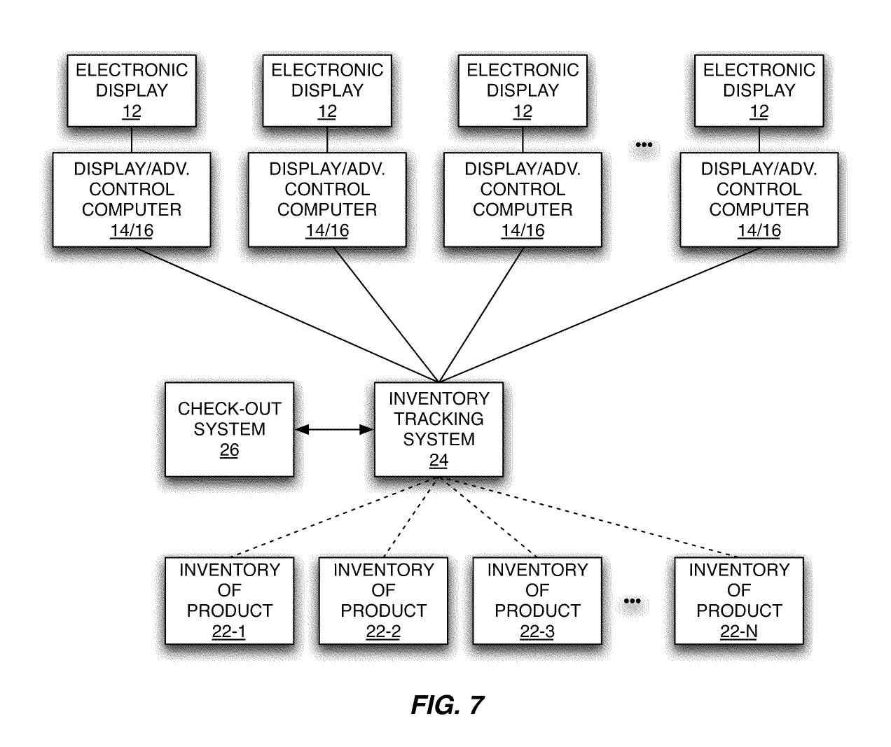

FIG. 7 illustrates another embodiment contemplated herein. In the illustrated embodiment, the display control computers 14 and the advertising control computers 16 are integrated together, with each display/advertising control computer pair 14/16 controlling at least one electronic display 12. Indeed, one computer can be configured via one or more computer programs and the appropriate communication and control interfaces to operate as both the display control computer 14 and die advertising control computer 16.

An inventory tracking system 24, such as introduced in FIG. 1, provides inventory information for a plurality of inventoried produces 22-1, 22-2, and so on. A check-out system 26 and/or the inventory tracking system 24 also may provide sales data, such as sales volume, sales rate, average sales data, sales trending information, etc. The display/advertising control computers 14/16 are, in at least one embodiment, configured to dynamically update one or more of the advertising playlists 28 responsive to changing inventory levels and/or responsive to sales performance data. Additionally or alternatively, the display/advertising control computers 14/16 dynamically update pricing information for one or more ads 20 included in the advertising playlists 28, based on inventory information and/or sales performance data.

In at least one embodiment, pricing updates are efficiently managed in that pricing information is carried in text or other display overlay data. Thus, to the extent that a given ad 20 is composed of audio, video, and/or image files, plus one or more text files carrying the changeable information, updating the pricing information in a given ad 20 is accomplished simply by updating the (typically small) text file that includes that information.

Further, in at least one embodiment contemplated herein, communication between the centralized advertising content server 70, advertising control computers 16, and display control computers 14 is secure. For example, AES-256 encryption can be used to protect the advertising playlists 28 and electronic content 32 flowing between nodes in the network. In a notable example, a Certificate Authority (CA) provides a PKI certificate for the centralized advertising content server 70 and corresponding certificates are issued on an individual basis for advertising control computers 16 and display control computers 14, so that PKI-based encryption may be used for node-to-node communications. In other embodiments, each node can be provisioned with the same shared secret, for secret-key-based encrypted communications between the nodes.

Of course, the present invention is not limited to the example embodiments, features, and advantages appearing in the foregoing discussion. Modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

What is claimed is:

1. An advertising display system comprising:
an electronic display for displaying advertisements; and
a display control computer configured to cause the electronic display to display a series of advertisements corresponding to inventoried products; and
an advertising control computer configured to compose said series and to modify product pricing information displayed in one or more of said advertisements, as a function of tracked inventory information for said inventoried products.

2. The advertising display system of claim 1, wherein the display control computer and the advertising control computer comprise one computer running one or more computer programs that functionally implement said display control computer and said advertising control computer.

3. The advertising display system of claim 1, wherein the display control computer and the advertising control computer comprise separate computers communicatively linked together via a local or remote communication connection.

4. The advertising display system of claim 1, wherein said advertising control computer is configured to compose said series by generating an advertising playlist, said advertising playlist identifying a set of electronic content files representing the advertisements to be included in said series, and wherein said display control computer is configured to read and follow said advertising playlist by loading respective ones of the electronic content files from said set of electronic content files for display on said electronic display, according to said advertising playlist.

5. The advertising display system of claim 4, wherein said advertising playlist includes playback control data that controls at least one of said following parameters during playback of said advertising playlist by said display control computer: a duration for displaying one or more of said advertisements in said playlist; whether scent generation is activated in conjunction with displaying one or more of said advertisements in said playlist; and whether visual highlighting is activated in conjunction with displaying one or more of said advertisements in said playlist.

6. The advertising display system of claim 4, wherein said advertising control computer includes at least one of: a communications interface for receiving the advertising playlist from an external source; a user interface configured for receiving user input representing advertising playlist selections, which are then used by said advertising control computer to generate the advertising playlist.

7. The advertising display system of claim 4, wherein said advertising control computer dynamically updates said advertising playlist as a function of changing levels of inventoried product, as indicated by said tracked inventory information.

8. The advertising display system of claim 1, wherein said advertising control computer is configured to compose said series by omitting an individual advertisement from a predefined series of advertisements responsive to determining that the inventoried product corresponding to the individual advertisement is out of stock, so as to prevent said electronic display from advertising products that are currently unavailable.

9. The advertising display system of claim 1, further comprising a data storage unit in or accessible to said display control computer, said data storage unit containing a set of advertisements, and wherein said advertising control computer is configured to compose said series based on selecting individual advertisements from said set based on at least one of: advertisement preference weightings reflecting relative amounts paid by advertisers associated with respective ones of the advertisements in said set of advertisements, relative inventory levels of the inventoried products associated with the set of advertisements, and sales performance data for the inventoried products corresponding to the advertisements in said set of advertisements.

10. The advertising display system of claim 1, wherein said advertising control computer composes said series as a function of said tracked inventory information by being configured to do one or more of: select individual advertisements from a set of advertisements for inclusion in said series; set the order in which individual advertisements in said series are displayed; set the duration for which individual advertisements in said series are displayed; and indicate whether advertisement highlighting is to be used for individual advertisements in said series, said advertisement highlighting comprising one or more visual, audible, or olfactory effects that can be activated by said display control computer in conjunction with causing a given advertisement to be displayed on said electronic display.

11. The advertising display system of claim 10, wherein said advertising control computer dynamically controls one or more advertising characteristics associated with displaying advertisements on said electronic display, based on relative levels of product inventory for those inventoried products corresponding to said advertisements in said series of advertisements, so that the advertisements corresponding to those products with relatively high levels of inventory are emphasized in relation to those products with relatively low levels of inventory.

12. The advertising computer system of claim 1, wherein said advertising control computer comprises a centralized advertising control server, and further comprising a plurality of said display control computers networked to said centralized advertising control server, and a plurality of said electronic displays, each said display control computer coupled to at least one of said electronic displays, and wherein said centralized advertising server is configured to send advertising playlists representing said composed series of advertisements for respective ones of said display control computers, and said centralized advertising server or said display control computers being further configured to dynamically update said advertising playlists as a function of said tracked inventory information.
